(19) United States
(12) Patent Application Publication
(10) Pub. No.: US 2014/0027212 A1
(43) Pub. Date: Jan. 30, 2014

(54) CORROSION PREVENTION DEVICE FOR VEHICLE BRAKE UNIT

(71) Applicants: Naotaka Nishida, Toyota-shi (JP); Satoru Turubuchi, Toyota-shi (JP); Yuta Karashima, Toyota-shi (JP); Sachio Hiramatsu, Toyota-shi (JP); Takahiro Ito, Miyoshi-shi (JP)

(72) Inventors: Naotaka Nishida, Toyota-shi (JP); Satoru Turubuchi, Toyota-shi (JP); Yuta Karashima, Toyota-shi (JP); Sachio Hiramatsu, Toyota-shi (JP); Takahiro Ito, Miyoshi-shi (JP)

(21) Appl. No.: 14/111,137

(22) PCT Filed: Apr. 11, 2011
(86) PCT No.: PCT/JP2011/059013

§ 371 Date: Oct. 10, 2013

(51) Int. Cl. F16D 65/00

(52) U.S. Cl. CPC F16D 65/0025
USPC 188/17

(57) ABSTRACT

A vehicle brake unit (10) includes a brake drum (11) as a rotating member of metal, brake shoes (12) as a friction engagement means, and a parking brake mechanism (20) for frictionally engaging the shoes (12) with a friction sliding surface (11a) of the drum (11) in accordance a parking brake operation by a driver. The brake unit (10) has a corrosion prevention device (30) composed of permanent magnets (31) and a coil (32) which constitute a power generation means, a battery (33) as a power storage means, and electrodes (34) as an electrical-conduction allowing means. By using electric power generated by the permanent magnets (31) and the coil (32) due to change in magnetic flux and stored in the battery (33), the corrosion prevention device (30) applies predetermined electric power to the drum (11) via the electrodes (34) which are electrically connected to the drum (11) when the brake shoes (12) are frictionally engaged with the friction sliding surface (11a) by the parking brake mechanism (20). Thus, the corrosion prevention device (30) electrically prevents corrosion of metal members of the brake unit (10).

### TECHNICAL FIELD

The present invention relates to a corrosion prevention device for a vehicle brake unit for use in an automobile or the like, and more particularly to a corrosion prevention device for a vehicle brake unit for preventing generation and progress of corrosion of metal members of a vehicle brake unit adapted to generate braking force through friction sliding.

### BACKGROUND ART

Conventionally, rust prevention treatment has been widely practiced for preventing generation of rust or corrosion of metal members of a vehicle brake unit for use in an automobile or the like. Known rust prevention treatment of this type is disclosed in, for example, the undermentioned Patent Document 1, which discloses a rotating brake member for a braking device for a vehicle and a rust prevention treatment method therefor. In the course of transport of a vehicle for overseas export, rust is apt to be generated on rotating brake members of a vehicle brake apparatus; specifically, on sliding surfaces of a brake drum and a brake disc rotor. Therefore, in the conventional rotating brake member for a braking device for a vehicle and the conventional rust prevention treatment method therefor, a phosphate film is formed on the sliding surfaces of the rotating brake members in order to prevent generation of rust. By means of the phosphate film being formed under predetermined conditions on the sliding surfaces of the rotating brake members, sufficient rust prevention effect can be exhibited to prevent generation of rust on the sliding surfaces of the rotating brake members until the vehicle is delivered to a user, and, after delivery of the vehicle to the user, the formed phosphate film does not have an adverse effect on braking performance.

### PRIOR ART DOCUMENT

### Patent Document

Patent Document 1: Japanese Patent Application Laid-Open (kokai) No. 2002-250377

### SUMMARY OF THE INVENTION

The conventional rotating brake member for a braking device for a vehicle and the conventional rust prevention treatment method therefor disclosed in the above-mentioned Patent Document 1 have a problem. So long as the formed phosphate film remains on the sliding surfaces of the rotating brake members, the rust prevention effect is exhibited; however, once the phosphate film formed on the sliding surfaces of the rotating brake members peels off, the rust prevention effect is lost. Meanwhile, even in ordinary situations of use, corrosion, such as rust, is apt to be readily generated on metal members of a vehicle brake unit; specifically, in the case where the vehicle brake unit is a disc brake unit, on a disc brake rotor, a hub bearing, a hub, etc., and, in the case where the vehicle brake unit is a drum brake unit, on a brake drum, a hub bearing, a hub, etc., and generated corrosion may progress over a wide range. In more specific conditions of use, for example, when rain falls on the disc brake rotor, the brake drum, the hub bearing, the hub, etc., of a vehicle parked in a users garage, corrosion (rust) may be generated on such metal members. When the vehicle is left parked for a long period of time in such a state that corrosion (rust) is generated, generated corrosion (rust) may progress over a wide range.

When, as mentioned above, in ordinary situations of use of a vehicle, corrosion (rust) is generated on metal members of a vehicle brake unit; specifically, on the disc brake rotor, the brake drum, the hub bearing, the hub, etc., the appearance of the vehicle becomes poor, and, upon generation of braking force, good brake feeling may be spoiled. Particularly, when corrosion (rust) is generated on the disc brake rotor, which is externally visible through an opening formed in a wheel of a vehicle, appearance of the vehicle is apt to be spoiled, and when corrosion (rust) is generated on a friction sliding surface of the disc brake rotor or the brake drum, useless vibration is generated upon generation of braking force (so-called a shuddering phenomenon), whereby a driver is likely to have a feeling of strangeness and may fail to have good brake feeling. Therefore, it is desirable to appropriately prevent generation of corrosion of metal members and progress of generated corrosion.

The present invention has been conceived to solve the above-mentioned problems, and an object of the invention is to provide a corrosion prevention device for a vehicle brake unit for restraining generation of corrosion and progress of generated corrosion of metal members of the vehicle brake unit by means of an electrolytic protection action.

In order to achieve the above object, a corrosion prevention device (the present device) for a vehicle brake unit is provided in the vehicle brake unit for applying braking force to a wheel of a vehicle and is adapted to restrain generation of corrosion and progress of generated corrosion of metal members of the vehicle brake unit by application of a predetermined current to the metal members. Thus, the present device is characterized by comprising power generation means, power storage means, and electrical-conduction allowing means.

The power generation means generates electric power through conversion of kinetic energy generated as a result of running of the vehicle to electric energy. The power storage means stores electric power generated by the power generation means. The electrical-conduction allowing means is electrically connected to the power storage means and allows application of the predetermined current to the metal members of the vehicle brake unit from the power storage means at least when the vehicle is stopped through application of braking force to the wheel from the vehicle brake unit.

According to this configuration, in a situation in which a vehicle is stopped, predetermined electric power (more specifically, current which cancels corrosion current induced by an electric potential difference between a corroded portion and an uncorroded portion of a metal member) is applied to metal members of the vehicle brake unit, whereby the electrolytic protection effect can be exhibited. Therefore, in ordinary situations of use of the vehicle; particularly, in a situation in which the vehicle is parked, the electrolytic protection effect can be exhibited; thus, there can be restrained (prevented) generation of corrosion and progress of generated corrosion of metal members of the vehicle brake unit, whereby good appearance can be maintained, and good brake feeling can be obtained.

A feature of the present device is as follows: the vehicle brake unit in which the present device is provided has a rotating member of metal encompassed in the metal members and rotating unitarily with the wheel, and friction engagement means which frictionally engages with the rotating member, and applies, as the braking force, friction force generated as a result of the friction engagement; in this case, the electrical-conduction allowing means is provided in the friction engagement means and allows application of electricity to the rotating member from the power storage means upon and during friction engagement of the friction engagement means with the rotating member. The vehicle brake unit is more specifically a so-called drum brake unit in which the rotating member is a brake drum rotating unitarily with the wheel and in which the friction engagement means is a brake shoe having lining to be frictionally engaged with a friction sliding surface formed on the brake drum. In these cases, the vehicle brake unit can be a drum-in disc brake in which the drum brake unit is integrally attached to a disc brake unit having a brake disc rotor rotating unitarily with the wheel, and a brake caliper accommodating a friction pad to be frictionally engaged with a friction sliding surface formed on the brake disc rotor.

According to these configurations, when a rotating member (friction sliding surface formed on the brake drum) of the vehicle brake unit and the friction engagement means (lining provided on the brake shoe) are frictionally engaged together; more specifically, at least when the vehicle is parked or stopped, the present device can apply predetermined electric power to rotating members (the brake drum, the hub bearing adapted to rotatably support the brake drum to a vehicle body, the hub, etc.) of the vehicle brake unit, thereby electrically preventing corrosion of the metal members. Therefore, in ordinary situations of use of the vehicle; particularly, in a situation in which the vehicle is parked or stopped, there can be restrained (prevented) generation of corrosion and progress of generated corrosion of metal members (the brake drum, the hub bearing, the hub, etc.) of the vehicle brake unit. By virtue of this restraint, good appearance can be maintained, and good brake feeling can be obtained through restraint of generation of useless vibration.

Also, a feature of the present device is as follows: the vehicle brake unit in which the present device is provided includes a parking brake mechanism for frictionally engaging the friction engagement means with the rotating member in response to a parking brake operation by a driver in parking the vehicle; in this case, the electrical-conduction allowing means allows application of electricity to the rotating member from the power storage means upon and during friction engagement of the friction engagement means with the rotating member caused by the parking brake mechanism in response to the parking brake operation by the driver.

According to this configuration, when the parking brake mechanism establishes friction engagement between a rotating member (friction sliding surface formed on the brake drum) of the vehicle brake unit and the friction engagement means (lining on the brake shoe) in response to a parking brake operation by a driver; i.e., when the driver parks or stops the vehicle, the present device can reliably apply predetermined electric power to a rotating member (brake drum) of the vehicle brake unit, thereby electrically preventing corrosion of the metal members. Therefore, in a situation in which the vehicle is parked or stopped, there can be reliably restrained (prevented) generation of corrosion and progress of generated corrosion of the metal members; i.e., of the rotating members (the brake drum, the hub bearing, etc.) of the vehicle brake unit, whereby good appearance can be maintained, and good brake feeling can be obtained.

Also, a feature of the present device is as follows: the vehicle brake unit in which the present device is provided has a rotating member of metal encompassed in the metal members and rotating unitarily with the wheel, and friction engagement means which frictionally engages with the rotating member, and applies, as the braking force, friction force generated as a result of the friction engagement; in this case, the electrical-conduction allowing means, together with biasing means for exerting biasing force on the electrical-conduction allowing means, is accommodated in an accommodation section formed in the rotating member; when the rotating member is not rotating with the wheel, the electrical-conduction allowing means is electrically connected to the power storage means by the biasing force exerted thereon by the biasing means, thereby allowing application of electricity to the rotating member; and when the rotating member is rotating with the wheel, the electrical-conduction allowing means is electrically disconnected from the power storage means by centrifugal force exerted thereon against the biasing force of the biasing means, thereby shutting off electricity to the rotating member. The vehicle brake unit is more specifically a disc brake unit in which the rotating member is a brake disc rotor rotating unitarily with the wheel and in which the friction engagement means is a brake caliper accommodating a friction pad to be frictionally engaged with a friction sliding surface formed on the brake disc rotor.

According to these configurations, when a rotating member (friction sliding surface formed on the brake disc rotor) of the vehicle brake unit and the friction engagement means (friction pad accommodated in the brake caliper) are frictionally engaged together, whereby a rotating member (brake disc rotor) is not rotating; i.e., at least when the wheel is not rotating, and the vehicle is parked or stopped, the present device can apply predetermined electric power to rotating members (the brake disc rotor, the hub bearing, the hub, etc.) of the vehicle brake unit, thereby electrically preventing corrosion of the metal members. Meanwhile, when the rotating member (friction sliding surface formed on the brake disc rotor) of the vehicle brake unit and the friction engagement means (friction pad accommodated in the brake caliper) are not frictionally engaged together, whereby the rotating member (brake disc rotor) is rotating; i.e., when the wheel is rotating, and the vehicle is not parked or stopped, the present device can shut off electricity to the rotating members (the brake disc rotor, the hub bearing, the hub, etc.) of the vehicle brake unit. Therefore, in ordinary situations of use of the vehicle; particularly, in a situation in which the vehicle is parked or stopped, there can be restrained (prevented) generation of corrosion and progress of generated corrosion of metal members, particularly the brake disc rotor, or a rotating member externally visible with ease, of the vehicle brake unit. By virtue of this restraint, good appearance can be maintained, and good brake feeling can be obtained through restraint of generation of useless vibration.

Also, a feature of the present device is as follows: the power generation means of the present device includes a permanent magnet and a coil provided in such a manner as to be displaceable relative to each other upon reception of kinetic energy generated as a result of running of a vehicle, and electric power is generated by converting the kinetic energy to the electric energy using changes in a magnetic field induced between the permanent magnet and the coil which undergo relative displacement caused by the kinetic energy. In this case, more specifically, the power generation means can be provided in a hub bearing adapted to connect the vehicle brake unit to an axle of a vehicle, and the permanent magnet can be attached to a rotating member of the hub bearing, whereas the coil can be attached to a stationary member of the hub bearing; alternatively, the coil can be attached to the rotating member of the hub bearing, whereas the permanent magnet can be attached to the stationary member of the hub bearing.

According to these configurations, the present device can directly convert kinetic energy generated as a result of running of the vehicle to electric energy, thereby generating electric power. The thus-generated electric power is stored in the power storage means, and the present device can utilize stored electric power for applying predetermined electric power to metal members of the vehicle brake unit, thereby electrically preventing corrosion of the metal members. Also, in this case, since the power generation means can be configured to include the permanent magnet and the coil, the present device can have a quite simple configuration, can be readily reduced in size and weight, and can be greatly reduced in manufacturing cost.

Furthermore, a feature of the present device is as follows: the vehicle brake unit in which the present device is provided applies braking force to the wheel through conversion of kinetic energy generated as a result of running of a vehicle to thermal energy; in this case, the power generation means includes a thermoelectric conversion element adapted to convert the thermal energy to the electric energy. In this case, more specifically, the thermoelectric conversion element of the power generation means is configured such that its one side is heated by the thermal energy generated by the vehicle brake unit, whereas its other side is cooled, and generates electric power through conversion of the thermal energy to the electric energy according to a temperature difference between the one side and the other side.

According to these configurations, the present device can generate electric power through conversion, to electric energy, of thermal energy generated inevitably as a result of application of braking force to the wheel. The thus-generated electric power is stored in the power storage means, and the present device can utilize stored electric power for applying predetermined electric power to metal members of the vehicle brake unit, thereby electrically preventing corrosion of the metal members. Also, in this case, since thermal energy radiated to the air can be collected and utilized, electric power can be generated quite efficiently.

### BRIEF DESCRIPTION OF THE DRAWINGS

FIG. 1 Sectional view relating to a first embodiment of the present invention and schematically showing the configuration of a vehicle brake unit, specifically a drum brake unit, to which a corrosion prevention device of the present invention can be applied.

FIG. 2 Schematic view specifically showing the configuration of a parking mechanism and the arrangement of the corrosion prevention device in the first embodiment.

FIG. 3 View for explaining the operation of the corrosion prevention device in the first embodiment.

FIGS. 4(a) and 4(b) Views for explaining the power generating and charging operations of the corrosion prevention device in the first embodiment.

FIG. 5 Schematic view showing the operation of the corrosion prevention device associated with the operation of the parking brake mechanism of FIG. 2.

FIGS. 6(a) and 6(b) Views for explaining the corrosion preventing operation (current applying operation) of the corrosion prevention device in the first embodiment.

FIG. 7 Sectional view relating to a second embodiment of the present invention and schematically showing the configuration of a vehicle brake unit, specifically a disc brake unit, to which a corrosion prevention device of the present invention can be applied.

FIG. 8 Schematic view specifically showing the arrangement of the corrosion prevention device in the second embodiment.

FIG. 9 View for explaining the operation of the corrosion prevention device in the second embodiment.

FIG. 10 View for explaining the operation of the corrosion prevention device in the course of running of a vehicle.

FIGS. 11(a) and 11(b) Views for explaining the power generating and charging operations and the corrosion preventing operation (current applying operation) of the corrosion prevention device in the second embodiment.

FIG. 12 View for explaining the operation of the corrosion prevention device when the vehicle is stopped.

FIG. 13 Sectional view relating to a first modified embodiment of the present invention and schematically showing the configuration of a vehicle brake unit, specifically a drum-in disc brake unit to which the corrosion prevention device of the present invention can be applied.

FIG. 14 Sectional view relating to a second modified embodiment of the present invention and schematically showing the configuration of a corrosion prevention device employing a thermoelectric conversion element as a power generation means.

### MODES FOR CARRYING OUT THE INVENTION

Corrosion prevention devices for a vehicle brake unit according to embodiments of the present invention will next be described in detail with reference to the drawings. A corrosion prevention device for a vehicle brake unit according to the present invention converts, to electric energy; i.e., electric power, kinetic energy generated as a result of running of a vehicle or thermal energy converted from kinetic energy in association with friction sliding in the vehicle brake unit, thereby generating and storing electric power. By use of the thus-stored electric power, the corrosion prevention device for a vehicle brake unit according to the present invention applies current to metal members of the vehicle brake unit; specifically, to a rotating member of metal having a friction sliding surface, thereby restraining (preventing) generation of corrosion (more specifically, rust) on the metal members of the vehicle brake unit, or restraining (preventing) progress of generated corrosion.

That is, the corrosion prevention device for the vehicle brake unit effectively utilizes electric energy (electric power) recovered from a running vehicle for restraining (preventing), by a so-called electrolytic protection action, generation of corrosion (rust) on metal members of the vehicle brake unit and progress of generated corrosion (rust).

### a. First Embodiment

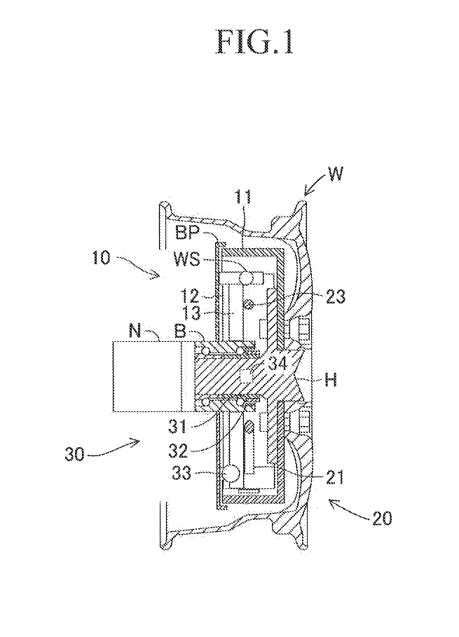

FIG. 1 relates to a first embodiment of the present invention and schematically shows the system configuration of a vehicle brake unit 10 to which a corrosion protection device for a vehicle brake unit is applied. The vehicle brake unit 10 (hereinafter, may be referred to merely as “brake unit 10”) in the first embodiment is a so-called drum brake unit. Thus, the brake unit 10 includes a brake drum 11 as a rotating member of metal encompassed in metal members of the brake unit 10, and brake shoes 12 as a friction engagement means to be frictionally engaged with the brake drum 11. Since a detailed structure and operation of the drum brake unit as the brake unit 10 are similar to those of a well known drum brake unit and do not relate directly to the present invention, the structure and operation of the brake unit 10 will be described briefly below.

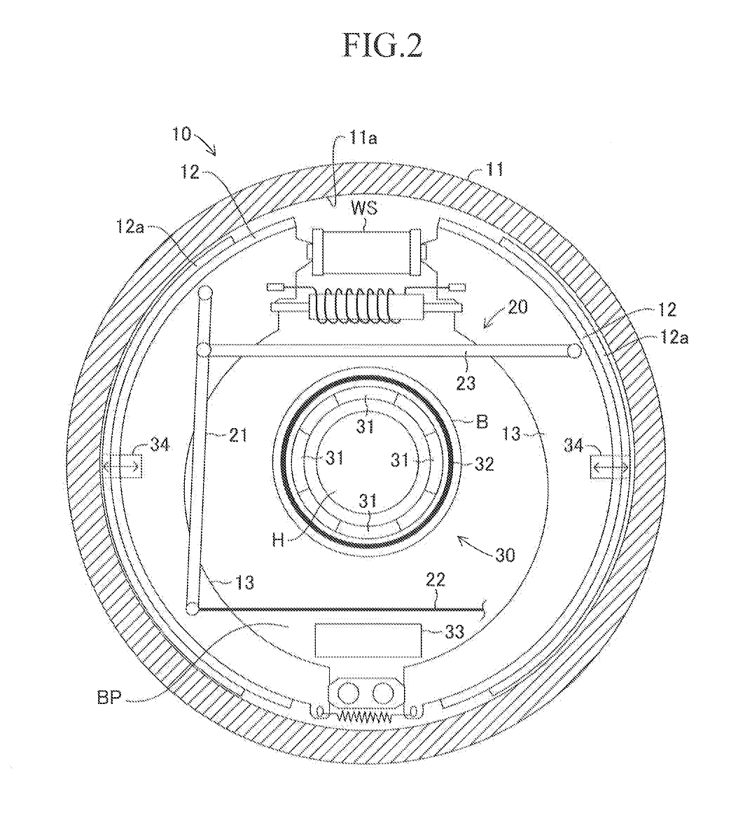

The brake drum 11 is attached, by use of nuts, to a hub H of metal rotatably supported by a rotating member of a hub bearing B of metal attached to a knuckle N of an unillustrated vehicle suspension system and encompassed in metal members (and rotating members) of the brake unit 10, and rotates unitarily with a wheel W. As shown in FIGS. 1 and 2, two brake shoes 12 are accommodated as a pair in the brake drum 11 and are attached, via respective shoe webs 13, to a back plate BP which is nonrotatably fixed to a vehicle body via a stationary member of the hub bearing B. The shoe webs 13 are rotatably attached to the back plat BP via pins and move the respective brake shoes 12 toward the inner circumferential surface (more specifically, a friction sliding surface 11a to be described later) of the brake drum 11. The shoe webs 13; i.e., the brake shoes 12, are configured such that the operation of a wheel cylinder WS causes their linings 12a as friction members to be frictionally engaged with the friction sliding surface 11a of the brake drum 11.

Also, the brake unit 10 in the first embodiment has a parking brake mechanism 20 which operates in response to a parking brake operation by a driver. As shown in FIGS. 1 and 2, the parking brake mechanism 20 has a brake lever 21 rotatably connected to one of the two shoe webs 13 of the brake unit 10. A brake cable 22 is connected to one end of the brake lever 21. Although unillustrated, the brake cable 22 is connected to a parking brake lever (or a parking brake pedal) to be manually operated by a driver, or to an electric actuator, such as a solenoid, which electrically operates in an interlocking relation with a parking brake switch operation or a like operation by a driver, and predetermined tensile force is applied to the brake cable 22. Also, a strut 23 linked to the other one of the two shoe webs 13 is connected to the other end of the brake lever 21. Thus, when a driver performs, for example, a parking brake operation in association with parking of a vehicle, the shoe webs 13; i.e., the brake shoes 12 operate such that tensile force applied to the brake cable 22 causes the linings 12a to be frictionally engaged with the friction sliding surface 11a of the brake drum 11.

In the thus-configured brake unit 10, when, during running of the vehicle, the driver steps on an unillustrated brake pedal for a brake operation, brake fluid pressure is supplied to the wheel cylinder WS. Accordingly, in association with an increase in the supplied brake fluid pressure, the brake shoes 12 (and the shoe webs 13) press their linings 12a against the friction sliding surface 11a of the brake drum 11, thereby establishing frictional engagement. Thus, friction force is generated on the brake drum 11 which is rotating unitarily with the wheel W, and the generated friction force becomes braking force for braking the wheel W.

In the thus-configured brake unit 10, when the driver performs a parking brake operation in parking or stopping a vehicle, the parking brake mechanism 20 operates. That is, when the driver operates a parking brake lever (parking brake pedal), a parking brake switch, or the like, predetermined tensile force is applied to the brake cable 22. When tensile force is applied to the brake cable 22 in this manner, the brake lever 21 rotates about a pin, thereby transmitting the tensile force to the other shoe web 13 via the strut 23. Accordingly, the brake shoe 12 unitarily fixed to the other shoe web 13 is pressed against the inner circumferential surface of the brake drum 11, whereby the lining 12a and the friction sliding surface 11a are frictionally engaged together. Meanwhile, when the brake shoe 12 is pressed against the inner circumferential surface of the brake drum 11 through transmission of the tensile force to the other shoe web 13, associated reaction force causes the brake shoe 12 unitarily fixed to the shoe web 13 connected to the brake lever 21 to be pressed against the inner circumferential surface of the brake drum 11, whereby the lining 12a and the friction sliding surface 11a are frictionally engaged together. Thus, friction force is generated on the brake drum 11 which is rotatable unitarily with the wheel W, and the generated friction force becomes braking force associated with the parking brake operation.

Next will be described a rust prevention device 30 (hereinafter, called merely the “present device 30”) for a vehicle brake unit which is applied to the thus-configured brake unit 10 (i.e., the drum brake unit). As shown in FIGS. 1 and 2, the present device 30 is composed of permanent magnets 31 and a coil 32 as a power generation means, a battery 33 as a power storage means, and electrodes 34 as an electrical-conduction allowing means.

As shown in FIGS. 1 and 2, a plurality of the permanent magnets 31 are provided along the outer circumferential surface of a rotating member (more specifically, a member which rotatably supports the hub H) of the hub bearing B and unitarily rotate in association with rotation of the wheel W (i.e., in association with running of a vehicle). As shown in FIGS. 1 and 2, the coil 32, which has a predetermined number of turns, is unitarily attached to the inside of a stationary member (more specifically, a member which nonrotatably supports the back plate BP) of the hub bearing B and is provided nonrotatably in relation to rotation of the wheel W; i.e., in relation to rotation of the permanent magnets 31. In this manner, through employment of the configuration in which the permanent magnets 31 rotate, whereas the coil 32 is disposed in such a manner as to encircle the rotating permanent magnets 31; in other words, by means of the permanent magnets 31 and the coil 32 being arranged in such a manner as to be displaceable relative to each other, magnetic flux can be changed, whereby so-called electromotive force can be generated in the coil 32 by electromagnetic induction; i.e., electric power can be generated in the coil 32.

In the first embodiment, the permanent magnets 31 are rotatably provided, whereas the coil 32 is nonrotatably provided; however, for example, so long as the coil 32 can be electrically connected to the battery 33 and the electrodes 34 through utilization of a slip ring or the like, it is, needless to say, possible that the permanent magnets 31 are nonrotatably provided, whereas the coil 32 is rotatably provided. That is, in the case where electromotive force is to be generated by electromagnetic induction through utilization of the permanent magnets 31 and the coil 32, since what is required for the permanent magnets 31 and the coil 32 is that the permanent magnets 31 and the coil 32 are displaceable relative to each other so as to exert magnetic flux change on at least the coil 32, the arrangement of the permanent magnets 31 and the coil 32 is not limited to the above.

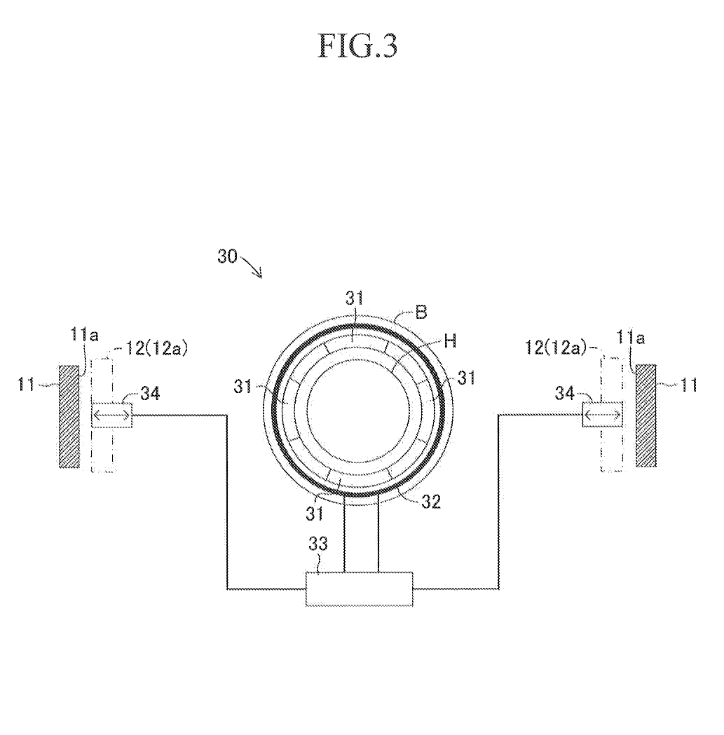

As shown in FIGS. 1 and 2, the battery 33 is attached to the back plate BP and is, as shown in FIG. 3, electrically connected to the coil 32 for storing generated electric power. Although unillustrated in FIG. 3, if needed, for example, an electric circuit (voltage transformation circuit) composed primarily of a DC-DC converter, a capacitor, etc., may be provided between the coil 32 and the battery 33, whereby the battery 33 receives electric power via the voltage transformation circuit.

As shown in FIG. 3, the electrodes 34 are electrically connected to the battery 33. As shown in FIGS. 1 and 2, the electrodes 34 are attached respectively to the two brakes shoes 12 of the brake unit 10. Thus, when the brake shoes 12 (more specifically, the linings 12a) frictionally engage with the brake drum 11 (more specifically, the friction sliding surface 11a), the electrodes 34 come into contact with the brake drum 11 (more specifically, the friction sliding surface 11a). Although unillustrated in FIG. 3, if needed, for example, an electric circuit (constant-current circuit) composed primarily of a resistor, etc., may be provided between the battery 33 and the electrodes 34, whereby predetermined current is supplied from the battery 33 via the constant-current circuit.

Thus, when the brake shoes 12 (more specifically, the linings 12a) are frictionally engaged with the brake drum 11 (more specifically, the friction sliding surface 11a): in other words; at least when the vehicle is stopped, the electrodes 34 function as switches for allowing predetermined current to be applied to the brake drum 11, to the hub bearing B to which the brake drum 11 is attached, and to the hub H through utilization of electric power stored in the battery 33. Also, when the brake shoes 12 (more specifically, the linings 12a) are not frictionally engaged with the brake drum 11 (more specifically, the friction sliding surface 11a); in other words; when the vehicle is running, the electrodes 34 function as switches for shutting off application of predetermined current to the brake drum 11, the hub bearing B, and the hub H.

Notably, the electrodes 34 may come into contact with the friction sliding surface 11a before a vehicle stops; in other words, when the brake drum 11 is still rotating. Thus, preferably, the electrodes 34 are formed from a material which is electrically conductive and is superior in wear resistance to the friction sliding surface 11a. By virtue of use of such a material, wear of the electrodes 34 can be reduced even in a situation in which braking force is generated through friction engagement between the brake shoes 12 and the friction sliding surface 11a of the rotating brake drum 11. Alternatively, through improvement of wear resistance of the linings 12a against the friction sliding surface 11a, there can be reduced wear of the electrodes 34 when the electrodes 34 are in contact with the friction sliding surface 11a.

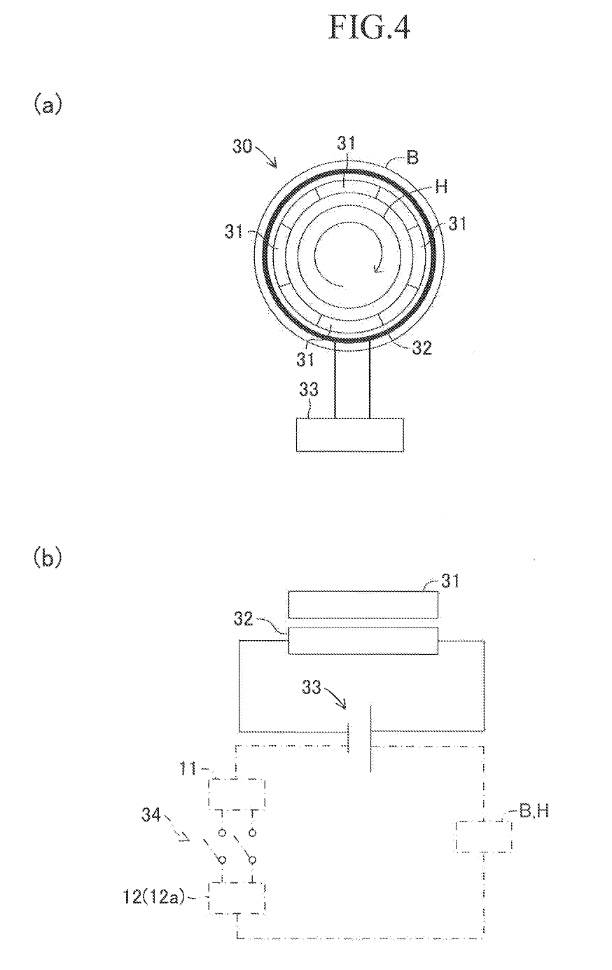

Next, the operation of the thus-configured present device 30 will be described. In a situation in which the vehicle is running, while the driver performs neither a brake operation nor a parking brake operation, as shown in FIG. 4(a), a plurality of the permanent magnets 31 of the power generation means of the present device 30 are rotationally displaced relative to the coil 32; as a result, magnetic flux changes, whereby the coil 32 generates electromotive force; i.e., electric power, through electromagnetic induction. As shown in FIG. 4(b), the thus-generated electric power is supplied to the battery 33 and is stored in the battery 33, for example, until the battery 33 is fully charged.

In the above-mentioned situation in which the vehicle is running, for example, when the driver performs a brake operation, as mentioned above, the wheel cylinder WS operates such that the linings 12a of the brake shoes 12 and the friction sliding surface 11a of the brake drum 11 are frictionally engaged together, whereby associated friction force induces braking force. When the linings 12a of the brake shoes 12 and the friction sliding surface 11a of the brake drum 11 are frictionally engaged together, electrical contact is established between the electrodes 34 electrically connected to the battery 33 and the friction sliding surface 11a of the brake drum 11 of metal, whereby, by use of electric power stored in the battery 33, current is applied to the brake drum 11, the hub bearing B, and the hub H. Such a state of application of predetermined current associated with a temporary stop in the course of running continues until the friction engagement between the linings 12a of the brake shoes 12 and the friction sliding surface 11a of the brake drum 11 is canceled.

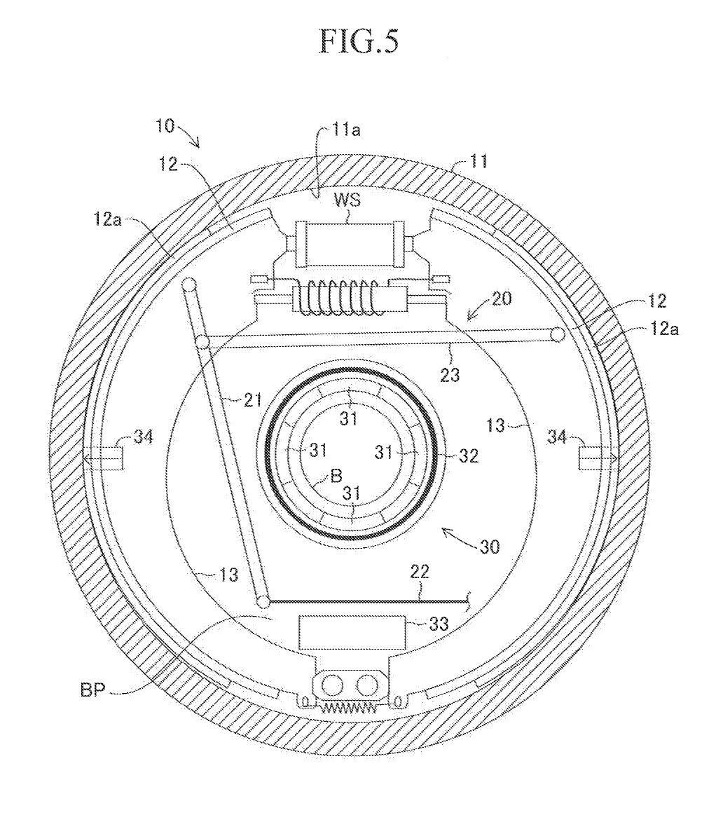

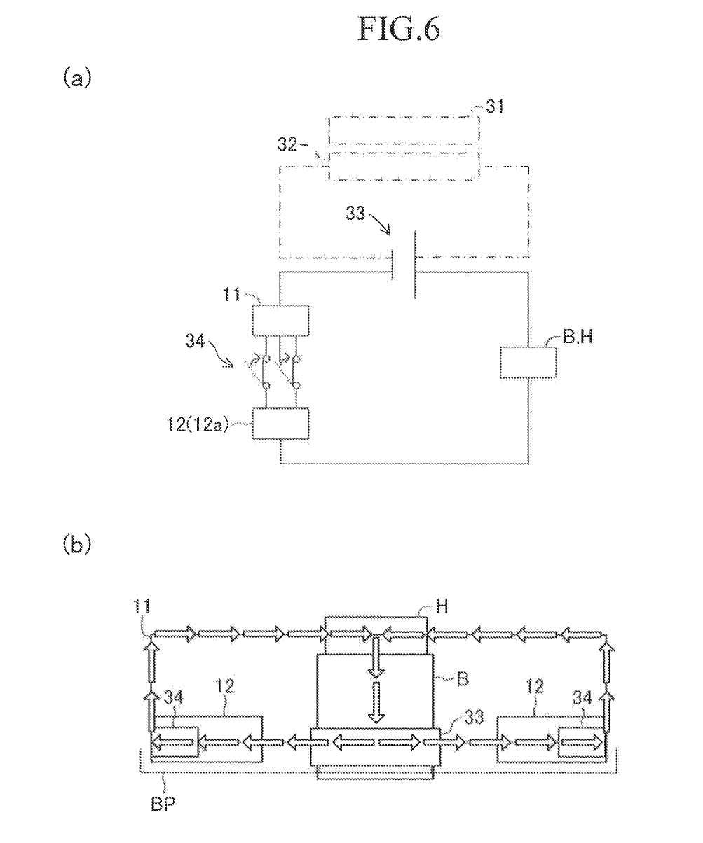

When the driver performs a parking brake operation for parking (stopping) the vehicle, as shown in FIG. 5, the parking brake mechanism 20 operates such that the linings 12a of the brake shoes 12 and the friction sliding surface 11a of the brake drum 11 are frictionally engaged together, whereby associated friction force induces braking force. When the linings 12a of the brake shoes 12 and the friction sliding surface 11a of the brake drum 11 are frictionally engaged together, as shown in FIG. 6(a), electrical contact is established between the electrodes 34 electrically connected to the battery 33 and the friction sliding surface 11a of the brake drum 11 of metal, whereby, as shown in FIG. 6(b), by use of electric power stored in the battery 33, predetermined current is applied to the brake drum 11, the hub bearing B, and the hub H. Such a state of application of current associated with parking continues over a relatively long period of time until the friction engagement between the linings 12a of the brake shoes 12 and the friction sliding surface 11a of the brake drum 11 is canceled.

Through application of predetermined current to metal members; specifically, to the brake drum 11, the hub bearing B, and the hub H, a so-called electrolytic protection action is exerted, whereby generation of corrosion (rust) of the metal members can be prevented. Specifically, corrosion (rust) of metal is generated or progresses according to the following mechanism: metal is ionized according to environmental conditions (e.g., humidity, etc.); in other words, the cell reaction consisting of the oxidation reaction (anodic reaction) and the reduction reaction (cathodic reaction) arises on the surface of metal, and current (corrosion current) generated as a result of the cell reaction flows. Thus, electrolytic protection is application of current to metal for canceling corrosion current induced by an electric potential difference between a corroded portion and an uncorroded portion of metal; i.e., application of current so as not to allow occurrence of an electric potential difference in metal for suppressing corrosion current, whereby an anticorrosive action can be exerted.

In a situation in which the vehicle is parked (stopped), for example, when humidity increases due to rain, corrosion (rust) is apt to be generated on metal members of the brake unit 10; specifically, on the brake drum 11, the hub bearing B, and the hub H. However, in this case, when the driver performs a parking brake operation, electrical contact is established between the electrodes 34 electrically connected to the battery 33 and the friction sliding surface 11a of the brake drum 11 of metal; thus, by use of electric power stored in the battery 33, predetermined current is applied to the brake drum 11, the hub bearing B, and the hub H, whereby an electric potential difference does not arise in the metal members, and, as a result, corrosion current does not flow. In this manner, through application of predetermined current to the brake drum 11, the hub bearing B, and the hub H, an electrolytic protection action can be reliably exerted, whereby there can be effectively restrained (prevented) generation of corrosion (rust) on metal members of the brake unit 10; specifically, on the brake drum 11, the hub bearing B, and the hub H.

As will be understood from the above description, in the case of the first embodiment, through appropriate exertion of an electrolytic protection action by the present device 30 in interlocking relation with a parking brake operation in parking the vehicle, there can be effectively restrained (prevented) generation of corrosion (rust) on metal members of the brake unit 10; specifically, on the brake drum 11, the hub bearing B, and the hub H. Thus, even in ordinary situations of use, good appearance can be maintained, and good brake feeling can be obtained through restraint of generation of useless vibration. Furthermore, since all of the permanent magnets 31, the coil 32, the battery 33, and the electrodes 34 used to form the present device 30 can be accommodated in the brake drum 11 of the brake unit 10, the device can be simplified and can be reduced in size.

### b. Second Embodiment

In the first embodiment described above, the vehicle brake unit 10 is embodied through employment of a drum brake unit structurally having the parking brake mechanism 20. Also, in the first embodiment described above, in interlocking relation with a parking brake operation by a driver in parking (stopping) a vehicle; i.e., in association with operation of the parking brake mechanism 20, predetermined current can be applied to metal members of the brake unit 10; specifically, to the brake drum 11, the hub bearing B, and the hub H, whereby an electrolytic protection action is reliably exerted, thereby effectively preventing generation of corrosion (rust). Meanwhile, the corrosion prevention device for a vehicle brake unit of the present invention can also be embodied through application to a so-called disc brake unit as the vehicle brake unit 10. The second embodiment will next be described in detail; however, like members of the first and second embodiments are denoted by like reference numerals, and repeated description thereof is omitted.

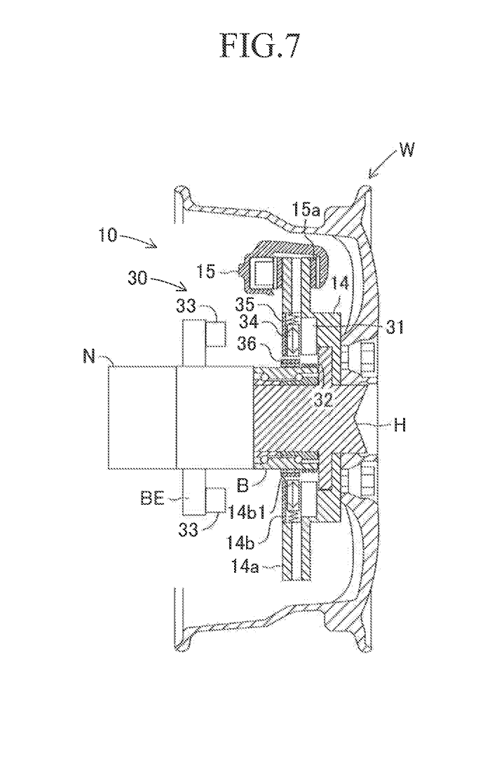

In the second embodiment, as shown in FIG. 7, since the brake unit 10 is a disc brake unit, the brake unit 10 includes a brake disc rotor 14 of metal as a rotating member of metal encompassed in metal members of the brake unit 10 and a brake caliper 15 as a friction engagement member. Since a detailed structure and operation of the disc brake unit as the brake unit 10 are similar to those of a well known disc brake unit and do not relate directly to the present invention, the structure and operation of the brake unit 10 will be described briefly below.

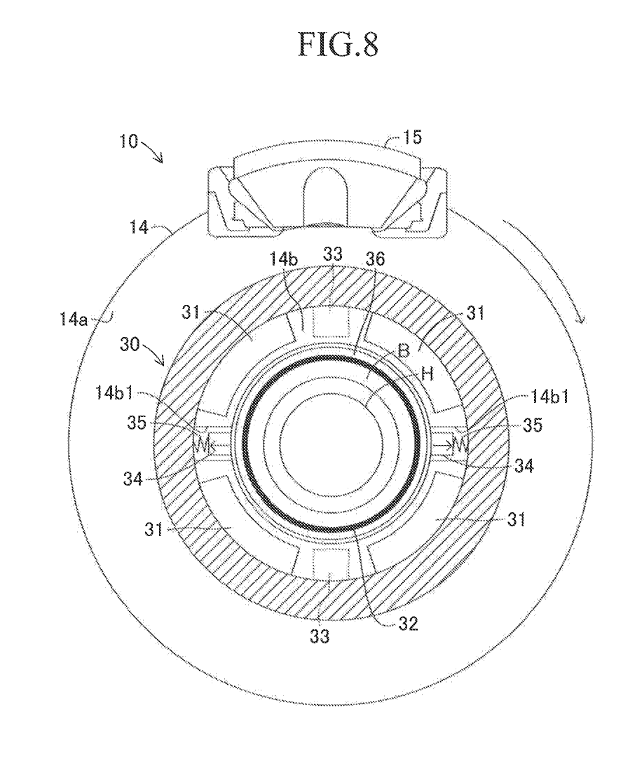

The brake disc rotor 14 is attached, by use of nuts, to the hub H of metal rotatably supported by the hub bearing B of metal attached to the knuckle N of an unillustrated suspension system and encompassed in metal members of the brake unit 10, and rotates unitarily with the wheel W. The brake disc rotor 14 may be of any type, such as a ventilated type disc rotor formed of two discs as shown in FIG. 7 or a solid type disc rotor formed of a single disc. As shown in FIGS. 7 and 8, the brake caliper 15 has a substantially U-shaped section in such a manner as to straddle the brake disc rotor 14 and accommodates friction pads 15a as a pair of friction members which face respective friction sliding surfaces 14a at opposite sides of the brake disc rotor 14.

In the thus-configured brake unit 10 in the second embodiment, when the driver steps on an unillustrated brake pedal for a brake operation, brake fluid pressure is supplied to the brake caliper 15. Accordingly, in association with an increase in the supplied brake fluid pressure, the brake caliper 15 presses the friction pads 15a against the respective friction sliding surfaces 14a of the brake disc rotor 14. Thus, the friction pads 15a are frictionally engaged with the friction sliding surfaces 14a of the brake disc rotor 14 which is rotating unitarily with the wheel W, thereby generating friction force, and the generated friction force becomes braking force for braking the wheel W.

As shown in FIGS. 7 to 9, the present device 30 applied to the thus-configured brake unit 10 in the second embodiment slightly differs from that in the first embodiment described above. The present device 30 in the second embodiment will next be described in detail.

Different from the first embodiment described above, the brake unit 10 in the second embodiment does not include the parking brake mechanism 20 to be unitarily incorporated therein. Therefore, as compared with the present device in the first embodiment, the present device 30 in the second embodiment is modified so as to be able to, particularly in parking or stopping the vehicle, apply current to metal members of the brake unit 10; specifically, to the brake disc rotor 14, the hub bearing B, and the hub H.

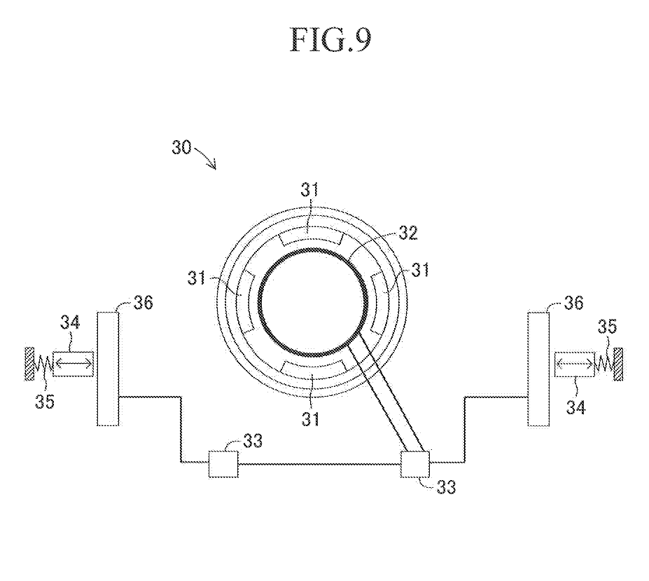

Specifically, the present device 30 is modified such that the electrodes 34, together with respective springs 35 as biasing means, are accommodated in respective accommodation sections 14b1 formed by disc members 14b in a hat section of the brake disc rotor 14. Also, in the second embodiment, the present device 30 is modified as follows: a plurality of the permanent magnets 31 are disposed circumferentially, for example, in the hat of the brake disc rotor 14 which rotates unitarily with the wheel W through connection to a rotating member of the hub bearing B, whereas the coil 32 is nonrotatably disposed on a stationary member of the hub bearing B, and the battery 33 is fixed to a disc plate BE provided on the stationary member of the hub bearing B. Furthermore, in the second embodiment, a slip ring 36 is provided on the stationary member of the hub bearing B via an insulator, and, as shown in FIG. 9, the slip ring 36 is electrically connected to the battery 33 as well as to the electrodes 34.

In the second embodiment, when the vehicle is running; i.e., when the brake disc rotor 14 is rotating, in association with an increase in centrifugal force exerted on the electrodes 34, the electrodes 34 are displaced against biasing force of the respective springs 35 within the respective accommodation sections 14b1 in a radial direction away from the center of the disc rotor 14; i.e., the electrodes 34 are displaced in a direction away from the slip ring 36, whereby the electrical connection between the electrodes 34 and the battery 33 is canceled, thereby shutting off application of current. Meanwhile, when the vehicle is decelerating in response to a brake operation by the driver, in association with a decrease in centrifugal force exerted on the electrodes 34, biasing force of the springs 35 causes the electrodes 34 to be displaced within the respective accommodation sections 14b1 in a radial direction toward the center of the brake disc rotor 14; i.e., the electrodes 34 are displaced in such a direction as to approach (come into contact with) the slip ring 36, whereby the electrodes 34 and the battery 33 are electrically connected together, thereby allowing application of current.

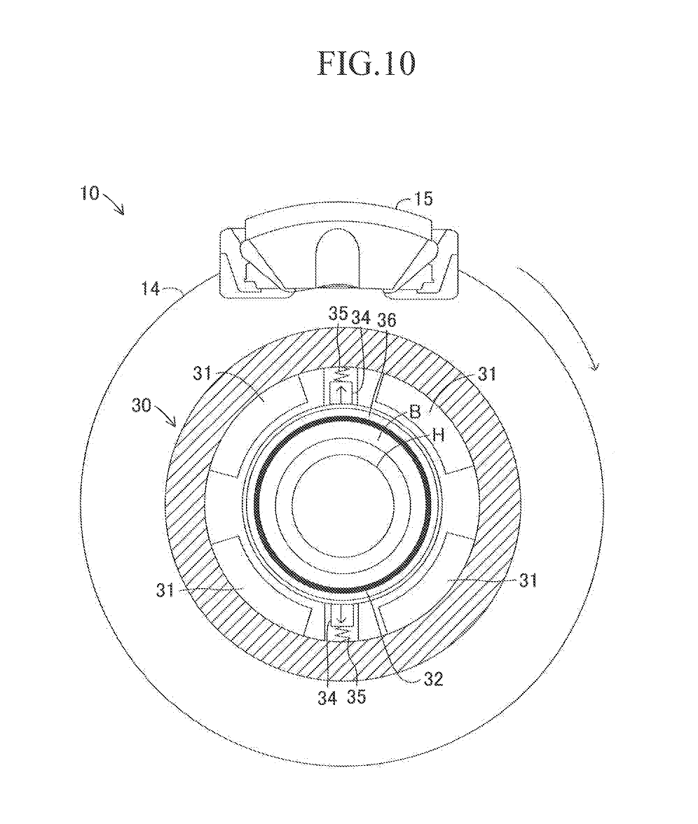

A set load ka of the spring 35 adapted to exert biasing force on the electrode 34 is described below. As mentioned above, according to the relationship between the magnitude of centrifugal force generated as a result of running of the vehicle and the magnitude of biasing force of the spring 35; i.e., the magnitude of the set load ka of the spring 35, the electrode 34 comes into contact with the slip ring 36, thereby allowing electrical conduction, or moves away from the slip ring 36, thereby shutting off electrical conduction. In this case, m represents the weight of the electrode 34; r₁ represents a radius indicative of the position of the rotating electrode 34 in the brake disc rotor 14; ω represents the angular velocity of the rotating electrode 34; g represents the gravitational acceleration; V represents the speed of the vehicle; and r₂ represents the tire dynamic load radius of the wheel W in the course of running of the vehicle. Now, suppose a situation (a moment) in which, as shown in FIG. 10, one of the two electrodes 34 is located at the upper position, whereas the other one is located at the lower position; then, the dynamic relations expressed by the following Eq. 1 and Eq. 2 hold true for the electrode 34 located at the upper position (hereinafter, called the upper electrode 34) and the electrode 34 located at the lower position (hereinafter, called the lower electrode 34).

Upper electrode 34: mg−mrω²+ka=0 Eq. 1

Lower electrode 34: mg+mrω²−ka=0 Eq. 2

Now, r appearing in Eqs. 1 and 2 is a radius indicative of the position of the electrode 34 in the brake disc rotor 14 as measured when power balance is established.

Eqs. 1 and 2 are arranged; then, the set load ka of the spring 35 can be expressed by the following Eq. 3.

ka=mr₁ω² Eq. 3

By use of the vehicle speed V and the tire dynamic load radius r₂, the angular velocity ω can be expressed by the following Eq. 4.

ω=V/3,600/(2πr₂)×2π Eq. 4

Therefore, the above Eqs. 3 and 4 can define the relationship between the vehicle speed V and the set load ka of the spring 35. Thus, for example, the set load ka of the spring 35 can be appropriately determined such that the electrode 34 and the slip ring 36 are separated from each other at a predetermined vehicle speed V0 or higher so as to shut off electrical conduction, whereas the electrode 34 and the slip ring 36 are brought into contact with each other at less than the vehicle speed V0 so as to allow electrical conduction.

In the second embodiment, the permanent magnets 31 are rotatably provided, whereas the coil 32 is nonrotatably provided; however, for example, so long as the coil 32 can be electrically connected to the battery 33 and the electrodes 34 through utilization of a slip ring or the like, it is, needless to say, possible that the permanent magnets 31 are nonrotatably provided, whereas the coil 32 is rotatably provided. That is, also in the second embodiment, in the case where electromotive force is to be generated by electromagnetic induction through utilization of the permanent magnets 31 and the coil 32, since what is required for the permanent magnets 31 and the coil 32 is that the permanent magnets 31 and the coil 32 are displaceable relative to each other so as to exert magnetic flux change on at least the coil 32, the arrangement of the permanent magnets 31 and the coil 32 is not limited to the above.

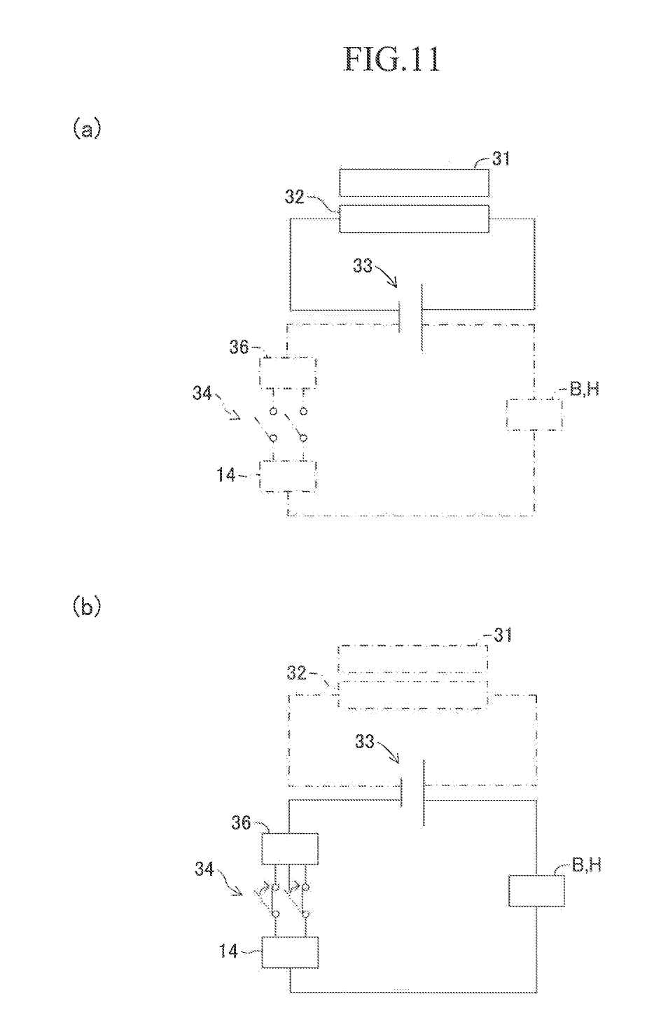

Next, the operation of the thus-configured present device 30 in the second embodiment will be described. In a situation in which the vehicle is running, while the driver does not perform a brake operation, even in the second embodiment, by means of a plurality of the permanent magnets 31 and the coil 32 of the power generation means of the present device 30 being rotationally displaced relative to each other, magnetic flux changes, whereby the coil 32 generates electromotive force through electromagnetic induction. As shown in FIG. 11(a), the thus-generated electric power is supplied to the battery 33 and is stored in the battery 33, for example, until the battery 33 is fully charged. In this situation, centrifugal force exerted on the electrodes 34 becomes greater than biasing force of the springs 35; accordingly, the electrodes 34 are separated from the slip ring 36, whereby electrical conduction is shut off.

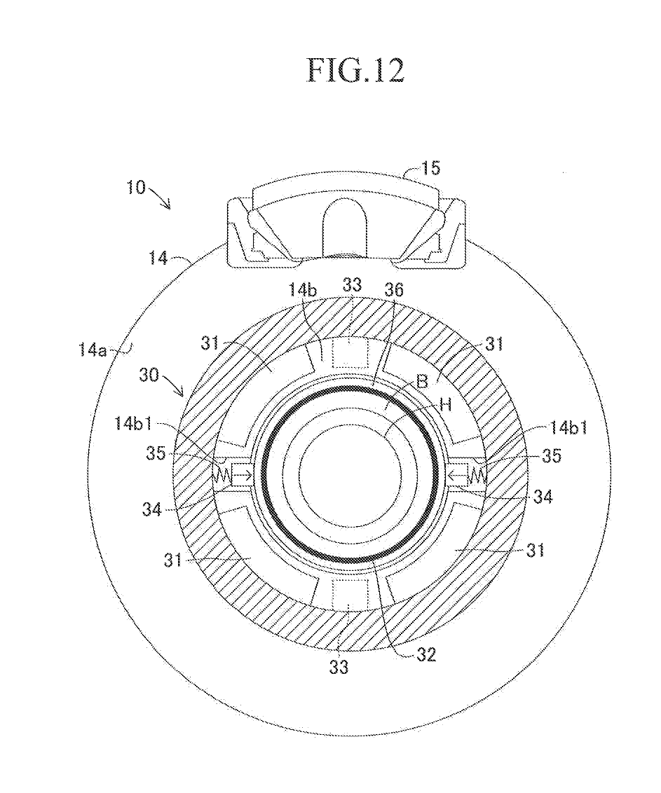

In the above-mentioned situation in which the vehicle is running, for example, when the driver performs a brake operation, as mentioned above, the brake caliper 15 operates such that the friction pads 15a and the friction sliding surfaces 14a of the brake disc rotor 14 are frictionally engaged together, whereby associated friction force induces braking force. When the thus-generated braking force causes the vehicle to decelerate and then stop, centrifugal force exerted on the electrodes 34 reduces, and, as shown in FIG. 12, biasing force of the springs 35 causes the electrodes 34 to come into contact with the slip ring 36, thereby allowing electrical conduction. Therefore, as shown in FIG. 11(b), by use of electric power stored in the battery 33, current is applied to metal members of the brake unit 10; specifically, to the brake disc rotor 14, the hub bearing B, and the hub H. Such a state of application of predetermined current in association with a temporary stop in the course of running of the vehicle continues until the electrodes 34 are separated from the slip ring 36 in association with the resumption of running of the vehicle which is accompanied by an increase in centrifugal force exerted on the electrodes 34 above biasing force of the springs 35.

When the driver parks (stops) the vehicle, as mentioned above, centrifugal force exerted on the electrodes 34 reduces to “0,” and, as shown in FIG. 12, biasing force of the springs 35 causes the electrodes 34 to come into contact with the slip ring 36, thereby allowing electrical conduction. That is, in a situation in which the vehicle is parked (stopped), the electrodes 34 and the battery 33 are electrically connected to each other via the slip ring 36, and, as shown in FIG. 11(b), by use of electric power stored in the battery 33, predetermined current is applied to the brake disc rotor 14, the hub bearing B, and the hub H. Such a state of application of current in association with parking continues over a relatively long period of time until the electrodes 34 are separated from the slip ring 36 in association with the resumption of running of the vehicle which is accompanied by an increase in centrifugal force exerted on the electrodes 34 above biasing force of the springs 35.

Thus, even in the case of the second embodiment, in a situation in which the vehicle is parked (stopped), for example, when humidity increases due to rain, corrosion (rust) is apt to be generated on metal members of the brake unit 10; specifically, on the brake disc rotor 14, the hub bearing B, and the hub H. However, even in this case, electrical contact is established between the electrodes 34 and the slip ring 36 electrically connected to the battery 33 so long as the vehicle is parked.

Thus, since, by use of electric power stored in the battery 33, predetermined current is applied to the brake disc rotor 14, the hub bearing B, and the hub H, even in the second embodiment, an electric potential difference does not arise in the brake disc rotor 14, the hub bearing B, and the hub H; as a result, corrosion current does not flow. That is, even in the case of the second embodiment, through application of predetermined current to the brake disc rotor 14, the hub bearing B, and the hub H, an electrolytic protection action can be reliably exerted, whereby there can be effectively prevented generation of corrosion (rust) on metal members of the brake unit 10; specifically, on the brake disc rotor 14, the hub bearing B, and the hub H.

As will be understood from the above description, in the case of the second embodiment, through appropriate exertion of an electrolytic protection action by the present device 30 in interlocking relation with parking or stopping of the vehicle, there can be effectively restrained (prevented) generation of corrosion (rust) on metal members of the brake unit 10; specifically, on the brake disc rotor 14, the hub bearing B, and the hub H. Thus, even in the case of the second embodiment, in ordinary situations of use, good appearance can be maintained, and good brake feeling can be obtained through restraint of generation of useless vibration. Furthermore, even in the case of the second embodiment, since all of the permanent magnets 31, the coil 32, the battery 33, the electrodes 34, the springs 35, and the slip ring 36 used to form the present device 30 can be disposed in the vicinity of the brake unit 10, the device can be simplified and can be reduced in size,

### c. First Modified Embodiment

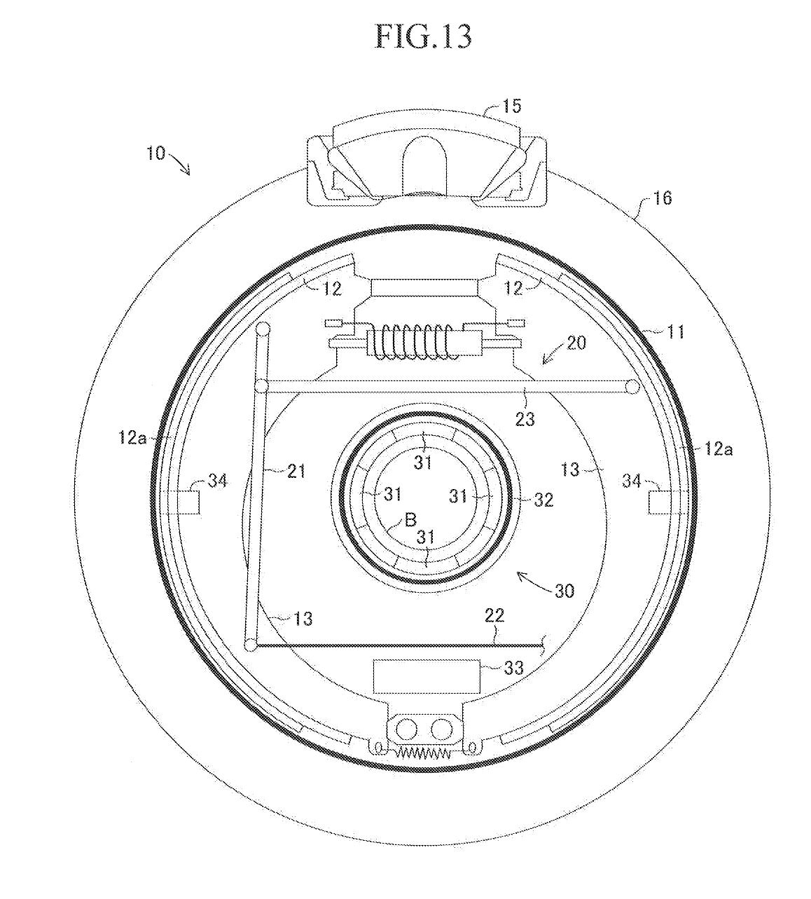

The first embodiment described above employs a drum brake unit as the vehicle brake unit 10, and the second embodiment described above employs a disc brake unit as the vehicle brake unit 10. Meanwhile, particularly, a vehicle brake unit employed for rear wheels of a vehicle may be a so-called drum-in disc brake unit in which, as shown in FIG. 13, a drum brake unit of metal is adjunctively attached to a disc brake unit, which has excellent cooling performance.

In this case, usually, the disc brake unit generates braking force for braking the wheel W in response to a brake operation by the driver, and, for example, when the driver performs a parking brake operation, a parking brake mechanism provided in the drum brake unit operates, whereby braking force can be applied to the wheel W in parking. Therefore, through employment of the vehicle brake unit 10 (the wheel cylinder WS is omitted) described in the section of the first embodiment in the drum-in disc brake unit, when the driver performs a brake operation, the parking brake mechanism 20 operates such that the linings 12a of the brake shoes 12 and the friction sliding surface 11a of the brake drum 11 are frictionally engaged together, whereby braking force can be induced by associated friction force.

In this manner, when the parking brake mechanism 20 causes the friction engagement between the linings 12a of the brake shoes 12 and the friction sliding surface 11a of the brake drum 11, electrical contact is established between the electrodes 34 electrically connected to the battery 33 and the friction sliding surface 11a of the brake drum 11 of metal. Thus, by use of electric power stored in the battery 33, predetermined current can be applied to the brake drum 11, the hub bearing B, and the hub H as well as to the brake disc rotor 16 of metal used to form the disc brake unit and formed integrally with the brake drum 11.

Therefore, even in a situation in which corrosion (rust) is apt to be generated on metal members of the brake unit 10; i.e., on the brake drum 11, the hub bearing B, the hub H, and the brake disc rotor 16, a parking brake operation by the driver establishes electrical contact between the electrodes 34 electrically connected to the battery 33 and the friction sliding surface 11a of the brake drum 11 of metal. Thus, by use of electric power stored in the battery 33, predetermined current is applied to the brake drum 11, the hub bearing B, the hub H, and the brake disc rotor 16, and an electric potential difference does not arise in these metal members; as a result, corrosion current does not flow. That is, even in the case of the first modified embodiment, through application of predetermined current to the brake drum 11, the hub bearing B, the hub H, and the brake disc rotor 16, an electrolytic protection action can be reliably exerted. Also, there can be effectively restrained (prevented) generation of corrosion (rust) on metal members of the brake unit 10; specifically, on the brake drum 11, the hub bearing B, the hub H, and the brake disc rotor 16.

As will be understood from the above description, even in the case of the first modified embodiment, similar to the first embodiment described above, through appropriate exertion of an electrolytic protection action by the present device 30 in interlocking relation with a parking brake operation in parking the vehicle, there can be effectively restrained (prevented) generation of corrosion (rust) on metal members of the brake unit 10; specifically, on the brake drum 11, the hub bearing B, the hub H, and the brake disc rotor 16. Thus, even in ordinary situations of use, good appearance can be maintained, and good brake feeling can be obtained through restraint of generation of useless vibration. Furthermore, even in the first modified embodiment, since all of the permanent magnets 31, the coil 32, the battery 33, and the electrodes 34 used to form the present device 30 can be accommodated in the brake drum 11 of the brake unit 10, the device can be simplified and can be reduced in size.

### d. Second Modified Embodiment

According to the embodiments and the first modified embodiment described above, by use of the permanent magnets 31 and the coil 32 as the power generation means, kinetic energy (i.e., relative rotational displacement between the permanent magnets 31 and the coil 32) generated as a result of running of the vehicle is converted directly to electric energy (i.e., electric power), and generated electric power is stored in the battery 33. In this case, in the embodiments and the first modified embodiment described above, the vehicle brake unit employs a brake unit which generates braking force through friction sliding; more specifically, a drum brake unit which generates braking force through friction sliding between the friction sliding surface 11a of the brake drum 11 and the linings 12a of the brake shoes 12, and a disc brake unit which generates braking force through friction sliding between the friction sliding surface 14a of the brake disc rotor 14 and the friction pads 15a of the brake caliper 15.

In the above-mentioned drum brake unit and disc brake unit, kinetic energy generated through running of the vehicle is converted to frictional heat; i.e., to thermal energy, through friction sliding, thereby generating braking force. Thus, in place of or in addition to conversion, directly to electric energy, of kinetic energy generated by use of the permanent magnets 31 and the coil 32 through running of the vehicle as mentioned above, thermal energy (frictional heat) generated inevitably in association with generation of braking force can be converted to electric energy (electric power), and the generated electric power can be stored in the battery 33. The second modified embodiment in which the power generation means is modified will be described below in detail. The second modified embodiment can employ either a drum brake unit or a disc brake unit as the vehicle brake unit 10; however, the following description illustrates the case of employment of the disc brake unit, which has excellent cooling performance and is described above in the section of the second embodiment.

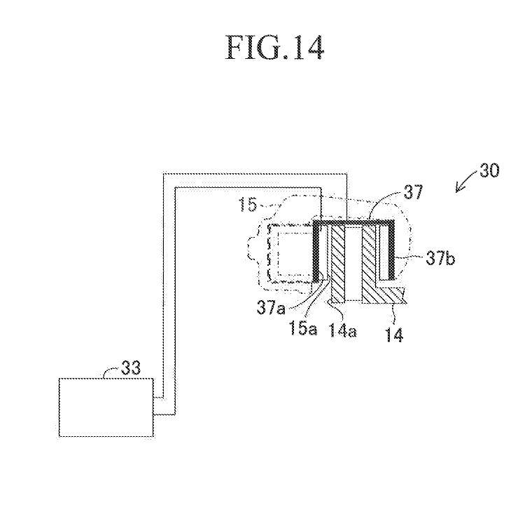

In order to convert generated thermal energy (frictional heat) to electric energy (electric power), the second modified embodiment employs, as the power generation means, a thermoelectric conversion element which utilizes the well-known Seebeck effect. That is, in the second modified embodiment, as shown in FIG. 14, the present device 30 includes, as the power generation means, a thermoelectric conversion element 37 in place of or in addition to the permanent magnets 31 and the coil 32 which are employed in the above-described embodiments and first modified embodiment.

The thermoelectric conversion element 37 converts thermal energy (frictional heat) to electric energy (electric power) through utilization of the well-known Seebeck effect which matter (specifically, a semiconductor) has. Thus, for example, in the case where the thermoelectric conversion element 37 is accommodated in the brake caliper 15, one side of the thermoelectric conversion element 37 is in close proximity to the brake disc rotor 14 (more specifically, the friction sliding surface 14a), thereby being heated by the above-mentioned frictional heat (thermal energy). Meanwhile, the other side of the thermoelectric conversion element 37 is located away from the brake disc rotor 14 (more specifically, the friction sliding surface 14a), thereby being cooled by, for example, the wind of a running vehicle.

In the following description, one side of the thermoelectric conversion element 37 which is located in close proximity to the brake disc rotor 14 (more specifically, the friction sliding surface 14a) and heated is called a heat surface 37a, and the other side of the thermoelectric conversion element 37 which is located away from the brake disc rotor 14 (more specifically, the friction sliding surface 14a) and cooled is called a cool surface 37b. Although detailed description is omitted, if needed, a voltage transformation circuit (e.g., an electric circuit composed primarily of a DC-DC converter, a capacitor, etc.) may be provided, whereby electric energy; i.e., electric power, generated through conversion by the thermoelectric conversion element 37 is supplied to the battery 33 via the voltage transformation circuit.

Next will be described the operation of the present device 30 which employs the thermoelectric conversion element 37 as the power generation means.

When the driver steps on an unillustrated brake pedal for a brake operation, the brake unit 10 applies braking force to rotation of the wheel W. That is, in the brake unit 10, the supply of brake fluid pressure to the brake caliper 15 in response to a brake pedal operation by the driver causes the friction pads 15a to be pressed against the friction sliding surface 14a of the brake disc rotor 14 rotating unitarily with the wheel W. Thus, the friction pads 15a and the friction sliding surface 14a of the brake disc rotor 14 are frictionally engaged together, thereby generating friction force, and the friction force is applied as braking force to the rotating wheel W. In a situation in which braking force is applied to the wheel W; i.e., friction force is generated, frictional heat (thermal energy) is generated on the friction sliding surface 14a of the brake disc rotor 14 and on the friction pads 15a of the brake caliper 15.

In the present device 30, the heat surface 37a of the thermoelectric conversion element 37 is quickly heated by frictional heat (thermal energy) transferred from the friction pads 15a of the brake caliper 15, whereas the cool surface 37b of the thermoelectric conversion element 37 is cooled by the wind of a running vehicle or the like which passes along the brake caliper 15. Thus, the thermoelectric conversion element 37 can efficiently convert thermal energy to electric energy; i.e., to electric power, according to a temperature difference between the heat surface 37a and the cool surface 37b by the well-known Seebeck effect, and the generated electric power can be stored in the battery 33.

Even in the case of the second modified embodiment, when the driver parks or stops the vehicle, similar to the second embodiment described above, centrifugal force exerted on the electrodes 34 reduces to “0,” and biasing force of the springs 35 causes the electrodes 34 to come into contact with the slip ring 36, thereby allowing electrical conduction. That is, in a situation in which the vehicle is parked or stopped, electrical contact is established between the electrodes 34 and the slip ring 36 electrically connected to the batteries 33, and, by use of electric power stored in the battery 33, predetermined current is applied to the brake disc rotor 14, the hub bearing B, and the hub H. Such a state of application of current in association with parking or stopping continues over a relatively long period of time until the electrodes 34 are separated from the slip ring 36 in association with the resumption of running of the vehicle which is accompanied by an increase in centrifugal force exerted on the electrodes 34 above biasing force of the springs 35.

Thus, even in the case of the second modified embodiment, in a situation in which the vehicle is parked, for example, when humidity increases due to rain, corrosion (rust) is apt to be generated on metal members of the brake unit 10; specifically, on the brake disc rotor 14, the hub bearing B, and the hub H. However, even in this case, electrical contact is established between the electrodes 34 and the slip ring 36 electrically connected to the battery 33 so long as the vehicle is parked or stopped.

Thus, since, by use of electric power (electric energy) converted from thermal energy and stored in the battery 33, predetermined current is applied to the brake disc rotor 14, the hub bearing B, and the hub H, an electric potential difference does not arise in the brake disc rotor 14, the hub bearing B, and the hub H; as a result, corrosion current does not flow. That is, even in the case of the second modified embodiment, through application of predetermined current to the brake disc rotor 14, the hub bearing B, and the hub H, an electrolytic protection action can be reliably exerted, whereby there can be effectively prevented generation of corrosion (rust) on metal members of the brake unit 10; specifically, on the brake disc rotor 14, the hub bearing B, and the hub H.

As will be understood from the above description, even in the case of the second modified embodiment, through appropriate exertion of an electrolytic protection action by the present device 30 in interlocking relation with parking of the vehicle, there can be effectively prevented generation of corrosion (rust) on metal members of the brake unit 10; specifically, on the brake disc rotor 14, the hub bearing B, and the hub H. Thus, in ordinary situations of use, good appearance can be maintained, and good brake feeling can be obtained through restraint of generation of useless vibration. Furthermore, even in the case of the second modified embodiment, since all of the permanent magnets 31, the coil 32, the battery 33, the electrodes 34, the springs 35, the slip ring 36, and the thermoelectric conversion element 37 used to form the present device 30 can be disposed in the vicinity of the brake unit 10, the device can be simplified and can be reduced in size.

The present invention is not limited to the above embodiments and modified embodiments, but may be embodied in various other forms without departing from the object of the invention.

For example, according to the embodiments and the first modified embodiment described above, the present device 30 has, as the power generation means, the permanent magnets 31 and the coil 32, and, through generation of magnetic flux change, kinetic energy generated as a result of running of the vehicle is converted directly to electric energy. Also, according to the second modified embodiment described above, in the case where the vehicle brake unit 10 applies braking force through conversion of kinetic energy to thermal energy, the present device 30 has the thermoelectric conversion element 37 as the power generation means and generates electric power through conversion of thermal energy to electric energy.

In this case, if the vehicle has an electric motor for driving and collecting electric power; for example, if the vehicle is an electric car, a hybrid car, a fuel-cell car, or the like, or if an ordinary vehicle has an electric motor for collecting electric power, through utilization of these electric motors, kinetic energy generated as a result of running of the vehicle can be converted directly to electric energy, thereby generating electric power, and the generated electric power can be stored in the battery 33 of the present device 30. In this manner, in the case where electric power is generated through utilization of an electric motor, there is no need to provide the power generation means, so that the configuration of the present device 30 can be greatly simplified, whereas the electrolytic protection effect can be reliably exhibited through utilization of the electric power stored in the battery 33. Therefore, even in this case, in ordinary situations of use, good appearance can be maintained, and good brake feeling can be obtained through restraint of generation of useless vibration.

Also, according to the first embodiment and the first modified embodiment described above, the electrodes 34 of the present device 30 are attached to the brake shoes 12 (more specifically, the linings 12a), and, when the brake shoes 12 (more specifically, the linings 12a) are frictionally engaged with the brake drum 11 (more specifically, the friction sliding surface 11a), the electrodes 34 come into contact with the friction sliding surface 11a. In this case, by means of the linings 12a of the brake shoes 12 being formed from a material which contains an electrically conductive material (e.g., copper), for example, even when the electrodes 34 are worn as a result of use over a long period of time, predetermined current can be applied to the brake drum 11 via the linings 12a in parking or stopping the vehicle. Therefore, even in this case, through utilization of electric power stored in the battery 33, the electrolytic protection effect can be reliably exhibited, and, in ordinary situations of use, good appearance can be maintained, and good brake feeling can be obtained through restraint of generation of useless vibration.

1. A corrosion prevention device for a vehicle brake unit provided in the vehicle brake unit for applying braking force to a wheel of a vehicle, and adapted to restrain generation of corrosion and progress of generated corrosion of metal members of the vehicle brake unit by application of a predetermined current to the metal members, comprising:
power generation means for generating electric power through conversion of kinetic energy generated as a result of running of the vehicle to electric energy;
power storage means for storing electric power generated by the power generation means; and
electrical-conduction allowing means electrically connected to the power storage means and allowing application of the predetermined current to the metal members of the vehicle brake unit from the power storage means at least when the vehicle is stopped through application of braking force to the wheel from the vehicle brake unit.

2. A corrosion prevention device for a vehicle brake unit according to claim 1, wherein
the vehicle brake unit has a rotating member of metal encompassed in the metal members and rotating unitarily with the wheel, and friction engagement means which frictionally engages with the rotating member, and applies, as the braking force, friction force generated as a result of the friction engagement, and
the electrical-conduction allowing means is provided in the friction engagement means and allows application of electricity to the rotating member from the power storage means upon and during friction engagement of the friction engagement means with the rotating member.

3. A corrosion prevention device for a vehicle brake unit according to claim 2, wherein the vehicle brake unit is a drum brake unit in which the rotating member is a brake drum rotating unitarily with the wheel and in which the friction engagement means is a brake shoe having lining to be frictionally engaged with a friction sliding surface formed on the brake drum.

4. A corrosion prevention device for a vehicle brake unit according to claim 3, wherein the vehicle brake unit is a drum-in disc brake in which the drum brake unit is integrally attached to a disc brake unit having a brake disc rotor rotating unitarily with the wheel, and a brake caliper accommodating a friction pad to be frictionally engaged with a friction sliding surface formed on the brake disc rotor.

5. A corrosion prevention device for a vehicle brake unit according to claim 2, wherein
the vehicle brake unit includes a parking brake mechanism for frictionally engaging the friction engagement means with the rotating member in response to a parking brake operation by a driver in parking the vehicle, and
the electrical-conduction allowing means allows application of electricity to the rotating member from the power storage means upon and during friction engagement of the friction engagement means with the rotating member caused by the parking brake mechanism in response to the parking brake operation by the driver.

6. A corrosion prevention device for a vehicle brake unit according to claim 1, wherein
the vehicle brake unit has a rotating member of metal encompassed in the metal members and rotating unitarily with the wheel, and friction engagement means which frictionally engages with the rotating member, and applies, as the braking force, friction force generated as a result of the friction engagement;
the electrical-conduction allowing means, together with biasing means for exerting bias force on the electrical-conduction allowing means, is accommodated in an accommodation section formed in the rotating member;
when the rotating member is not rotating with the wheel, the electrical-conduction allowing means is electrically connected to the power storage means by the biasing force exerted thereon by the biasing means, thereby allowing application of electricity to the rotating member; and
when the rotating member is rotating with the wheel, the electrical-conduction allowing means is electrically disconnected from the power storage means by centrifugal force exerted thereon against the biasing force of the biasing means, thereby shutting off electricity to the rotating member.

7. A corrosion prevention device for a vehicle brake unit according to claim 6, wherein the vehicle brake unit is a disc brake unit in which the rotating member is a brake disc rotor rotating unitarily with the wheel and in which the friction engagement means is a brake caliper accommodating a friction pad to be frictionally engaged with a friction sliding surface formed on the brake disc rotor.

8. A corrosion prevention device for a vehicle brake unit according to claim 1, wherein
the power generation means includes a permanent magnet and a coil provided in such a manner as to be displaceable relative to each other upon reception of kinetic energy generated as a result of running of a vehicle, and
electric power is generated by converting the kinetic energy to the electric energy using changes in a magnetic field induced between the permanent magnet and the coil which undergo relative displacement caused by the kinetic energy.

9. A corrosion prevention device for a vehicle brake unit according to claim 8, wherein
the power generation means is provided in a hub bearing adapted to connect the vehicle brake unit to an axle of a vehicle, and
the permanent magnet is attached to a rotating member of the hub bearing, whereas the coil is attached to a stationary member of the hub bearing; alternatively, the coil is attached to the rotating member of the hub bearing, whereas the permanent magnet is attached to the stationary member of the hub bearing.

10. A corrosion prevention device for a vehicle brake unit according to claim 1, wherein
the vehicle brake unit applies braking force to the wheel through conversion of kinetic energy generated as a result of running of a vehicle to thermal energy, and
the power generation means includes a thermoelectric conversion element adapted to convert the thermal energy to the electric energy.

11. A corrosion prevention device for a vehicle brake unit according to claim 10, wherein the thermoelectric conversion element of the power generation means is configured such that its one side is heated by the thermal energy generated by the vehicle brake unit, whereas its other side is cooled, and generates electric power through conversion of the thermal energy to the electric energy according to a temperature difference between the one side and the other side.
